(19) United States
(12) Patent Application Publication
(10) Pub. No.: US 2008/0040315 A1
(43) Pub. Date: Feb. 14, 2008

(54) Systems and methods for generating a user interface

(76) Inventors: David Benjamin Auerbach, Brooklyn, NY (US); Stephen Lawrence, Mountain View, CA (US)

Correspondence Address: GOOGLE / FENWICK, SILICON VALLEY CENTER, 801 CALIFORNIA ST., MOUNTAIN VIEW, CA, 94041, US

(21) Appl. No.: 10/814,052

(22) Filed: Mar. 31, 2004

(51) Int. Cl. G06F 17/30

(52) U.S. Cl. 707/3

(57) ABSTRACT

Systems and methods for generating a user interface are described. In one described system, an aspect associated with an article is identified. Next, an insert comprising a search result is generated based, at least in part, on the aspect. The insert is then caused to be output in association with the aspect.

### RELATED APPLICATIONS

This application relates to co-pending applications Ser. No. 10/______ (Attorney Docket No. GP-175-12-US), filed Mar. 31, 2004, entitled “SYSTEMS AND METHODS FOR GENERATING MULTIPLE IMPLICIT SEARCH QUERIES;” Ser. No. 10/______ (Attorney Docket No. GP-175-13-US), filed Mar. 31, 2004, entitled “SYSTEMS AND METHODS FOR EXTRACTING A KEYWORD FROM AN EVENT;” Ser. No. 10/______ (Attorney Docket No. GP-175-14-US), filed Mar. 31, 2004, entitled “SYSTEMS AND METHODS FOR WEIGHTING A SEARCH QUERY RESULT;” Ser. No. 10/______ (Attorney Docket No. GP-175-15-US), filed Mar. 31, 2004, entitled “SYSTEMS AND METHODS FOR REFRESHING A CONTENT DISPLAY;” Ser. No. 10/______ (Attorney Docket No. GP-175-16-US), filed Mar. 31, 2004, entitled “METHODS OF CONSTRUCTING AND USING A USER PROFILE IN SCORING;” Ser. No. 10/______ (Attorney Docket No. GP-175-17-US), filed Mar. 31, 2004, entitled “SYSTEMS AND METHODS FOR IDENTIFYING A NAMED ENTITY;” Ser. No. 10/______ (Attorney Docket No. GP-175-18-US), filed Mar. 31, 2004, entitled “SYSTEMS AND METHODS FOR ANALYZING BOILERPLATE;” Ser. No. 10/______ (Attorney Docket No. GP-175-38-US), filed Mar. 31, 2004, entitled “SYSTEMS AND METHODS FOR ASSOCIATING A KEYWORD WITH A USER INTERFACE AREA;” Ser. No. 10/______ (Attorney Docket No. GP-175-39-US), filed Mar. 31, 2004, entitled “SYSTEMS AND METHODS FOR RANKING IMPLICIT SEARCH RESULTS;” and Ser. No. 10/______ (Attorney Docket No. GP-175-51-US), filed Mar. 31, 2004, entitled “SYSTEMS AND METHODS FOR PROVIDING SEARCH RESULTS,” the disclosures of which are incorporated herein by reference.

### FIELD OF THE INVENTION

The present invention relates generally to user interfaces. The present invention relates particularly to methods and systems for generating a user interface.

### BACKGROUND

Conventional search engines receive a search query from a user and execute a search against a global index. Such conventional search engines typically use one or more conventional methods for performing a search. For example, one known method, described in an article entitled “The Anatomy of a Large-Scale Hypertextual Search Engine,” by Sergey Brin and Lawrence Page, assigns a degree of importance to a document, such as a web page, based on the link structure of the web. The search results are often presented in a list format, comprising article identifiers and brief snippets about the documents.

Various client applications include interfaces that combine various types of information. For example, some conventional productivity tools allow a user to view tasks and calendar entries simultaneously. Conventional applications do not, however, provide the user with the capability of combining the results of searches of both local and global information in a single, unified interface in an effective manner. Also, conventional search engines do not effectively allow the user to combine the results of a search of a messaging index with other search results.

Thus, a need exists to provide an improved system and method for providing a user interface.

### SUMMARY

Embodiments of the present invention provide systems and methods for generating a user interface. One embodiment of the present invention comprises identifying an aspect associated with an article, generating an insert based, at least in part, on the aspect, and causing the insert to be output in association with the aspect. The insert may comprise a search result. In another embodiment, the insert may comprise a request.

These exemplary embodiments are mentioned not to limit or define the invention, but to provide examples of embodiments of the invention to aid understanding thereof. Exemplary embodiments are discussed in the Detailed Description, and further description of the invention is provided there. Advantages offered by the various embodiments of the present invention may be further understood by examining this specification.

### BRIEF DESCRIPTION OF THE FIGURES

These and other features, aspects, and advantages of the present invention are better understood when the following Detailed Description is read with reference to the accompanying drawings, wherein:

FIG. 1 is a block diagram illustrating an exemplary environment in which one embodiment of the present invention may operate;

FIG. 2 is a flowchart illustrating generating a user interface in a first embodiment of the present invention;

FIG. 3 is a flowchart illustrating generating a user interface in a second embodiment of the present invention;

FIG. 4 is a flowchart illustrating generating a user interface in a third embodiment of the present invention;

FIG. 5 is a screen shot illustrating a user interface according to a first embodiment of the present invention;

FIG. 6 is a screen shot illustrating a user interface according to a second embodiment of the present invention; and

FIG. 7 is a screen shot illustrating a user interface according to a third embodiment of the present invention.

### DETAILED DESCRIPTION

Embodiments of the present invention provide systems and methods for generating a user interface. Exemplary embodiments are described below.

### System Architecture

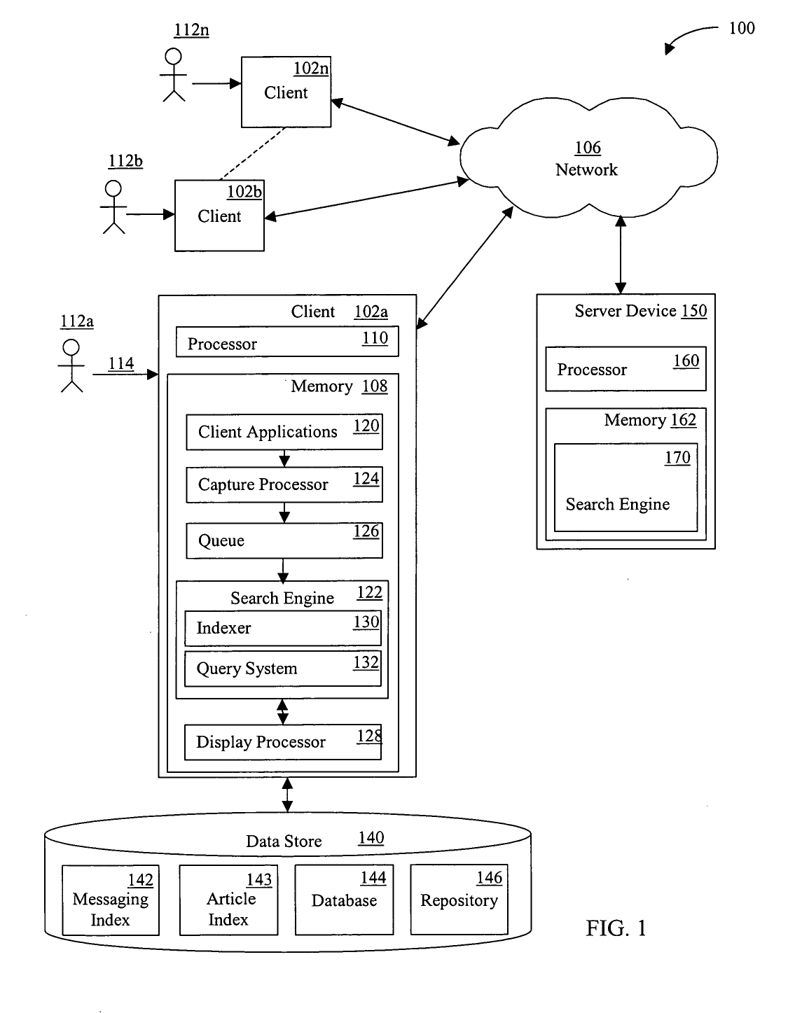

Referring now to the drawings in which like numerals indicate like elements throughout the several figures, FIG. 1 is a block diagram illustrating an exemplary environment for implementation of an embodiment of the present invention. While the environment shown in FIG. 1 reflects a client-side search engine architecture embodiment, other embodiments are possible. The system 100 shown in FIG. 1 includes multiple client devices 102a-n that can communicate with a server device 150 over a network 106. The network 106 shown in FIG. 1 comprises the Internet. In other embodiments, other networks, such as an intranet, may be used instead. Moreover, methods according to the present invention may operate within a single client device that does not communicate with a server device or a network.

The client devices 102a-n shown in FIG. 1 each include a computer-readable medium 108. The embodiment shown in FIG. 1 includes a random access memory (RAM) 108 coupled to a processor 110. The processor 110 executes computer-executable program instructions stored in memory 108. Such processors may include a microprocessor, an ASIC, state machines, or other processor, and can be any of a number of suitable computer processors, such as processors from Intel Corporation of Santa Clara, Calif. and Motorola Corporation of Schaumburg, Ill. Such processors include, or may be in communication with, media, for example computer-readable media, which stores instructions that, when executed by the processor, cause the processor to perform the steps described herein. Embodiments of computer-readable media include, but are not limited to, an electronic, optical, magnetic, or other storage or transmission device capable of providing a processor, such as the processor 110 of client 102a, with computer-readable instructions. Other examples of suitable media include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any suitable computer-programming language, including, for example, C, C++, C#, Visual Basic, Java, Python, Perl, and JavaScript.

Client devices 102a-n can be coupled to a network 106, or alternatively, can be stand alone machines. Client devices 102a-n may also include a number of external or internal devices such as a mouse, a CD-ROM, DVD, a keyboard, a display device, or other input or output devices. Examples of client devices 102a-n are personal computers, digital assistants, personal digital assistants, cellular phones, mobile phones, smart phones, pagers, digital tablets, laptop computers, Internet appliances, and other processor-based devices. In general, the client devices 102a-n may be any type of processor-based platform that operates on any suitable operating system, such as Microsoft® Windows® or Linux, capable of supporting one or more client application programs. For example, the client device 102a can comprise a personal computer executing client application programs, also known as client applications 120. The client applications 120 can be contained in memory 108 and can include, for example, a word processing application, a spreadsheet application, an email application, an instant messenger application, a presentation application, an Internet browser application, a media player application, a calendar/organizer application, a video playing application, an audio playing application, an image display application, a file management program, an operating system shell, and other applications capable of being executed by a client device. Client applications may also include client-side applications that interact with or access other applications (such as, for example, a web-browser executing on the client device 102a that interacts with a remote e-mail server to access e-mail).

The user 112a can interact with the various client applications 120 and articles associated with the client applications 120 via various input and output devices of the client device 102a. Articles include, for example, word processor documents, spreadsheet documents, presentation documents, emails, instant messenger messages, database entries, calendar entries, appointment entries, task manager entries, source code files, and other client application program content, files, messages, items, web pages of various formats, such as HTML, XML, XHTML, Portable Document Format (PDF) files, and media files, such as image files, audio files, and video files, chat messages, email messages, or any other documents or items or groups of documents or items or information of any suitable type whatsoever.

The user's 112a interaction with articles, the client applications 120, and the client device 102a creates event data that may be observed, recorded, analyzed or otherwise used. An event can be any occurrence possible associated with an article, client application 120, or client device 102a, such as inputting text in an article, displaying an article on a display device, sending an article, receiving an article, manipulating an input device, opening an article, saving an article, printing an article, closing an article, opening a client application program, closing a client application program, idle time, processor load, disk access, memory usage, bringing a client application program to the foreground, changing visual display details of the application (such as resizing or minimizing) and other suitable occurrences associated with an article, a client application program, or the client device. Additionally, event data can be generated when the client device 112a interacts with an article independent of the user 112a, such as when receiving an email or performing a scheduled task.

The memory 108 of the client device 102a can also contain a capture processor 124, a queue 126, and a search engine 122. The client device 102a can also contain or is in communication with a data store 140. The capture processor 124 can capture events and pass them to the queue 126. The queue 126 can pass the captured events to the search engine 122 or the search engine 122 can retrieve new events from the queue 126. In one embodiment, the queue 126 notifies the search engine 122 when a new event arrives in the queue 126 and the search engine 122 retrieves the event (or events) from the queue 126 when the search engine 122 is ready to process the event (or events). When the search engine receives an event it can be processed and can be stored in the data store 140. The search engine 122 can receive an explicit query from the user 112a or generate an implicit query and retrieve information from the data store 140 in response to the query. In another embodiment, the queue is located in the search engine 122. In still another embodiment, the client device 102a does not have a queue and the events are passed from the capture processor 124 directly to the search engine 122. According to other embodiments, the event data is transferred using an information exchange protocol. The information exchange protocol can comprise, for example, any suitable rule or convention facilitating data exchange, and can include, for example, any one of the following communication mechanisms: Extensible Markup Language—Remote Procedure Calling protocol (XML/RPC), Hypertext Transfer Protocol (HTTP), Simple Object Access Protocol (SOAP), shared memory, sockets, local or remote procedure calling, or any other suitable information exchange mechanism.

The capture processor 124 can capture an event by identifying and extracting event data associated with an event. Examples of events include sending or receiving an instant messenger message, a user viewing a web page, saving a word processing document, printing a spreadsheet document, inputting text to compose or edit an email, opening a presentation application, closing an instant messenger application, entering a keystroke, moving the mouse, and hovering the mouse over a hyperlink. An example of event data captured by the capture processor 124 for an event involving the receipt of an instant messenger message by the user 112a can comprise the sender of the message, the recipients of the message, the time and date the message was received, the content of the message and a conversation ID. A conversation ID can be used to associate messages that form a conversation and can be provided by the instant messenger application or can be generated by the capture processor 124. A conversation can be one or more messages between the user 112a and at least one other user until the user 112a logs out of or closes the instant messenger application or the instant messenger application is inactive for a certain period of time (for example, 30 minutes). Another example of event data captured by the capture processor 124 for an event involving the viewing of a web page by a user can comprise the URL of the web page, the time and date the user viewed the web page, the content of the web page in original or processed forms, a screenshot of the page as displayed to the user, and a thumbnail version of the screenshot.

In the embodiment shown in FIG. 1, the capture processor 124 comprises multiple capture components. For example, the capture processor 124 shown in FIG. 1 comprises a separate capture component for each client application in order to capture events associated with each application. The capture processor 124 can also comprises a separate capture component that monitors overall network activity in order to capture event data associated with network activity, such as the receipt or sending of an instant messenger message. The capture processor 124 shown in FIG. 1 also can comprise a separate client device capture component that monitors overall client device performance data, such as processor load, idle time, disk access, the client applications in use, and the amount of memory available. The capture processor 124 shown in FIG. 1 also comprises a separate capture component to monitor and capture keystrokes input by the user and a separate capture component to monitor and capture items, such as text, displayed on the display device associated with the client device 102a. An individual capture component can monitor multiple client applications and multiple capture components can monitor different aspects of a single client application.

In one embodiment, the capture processor 124, through the individual capture components, can monitor activity on the client device and can capture events by a generalized event definition and registration mechanism, such as an event schema. Each capture component can define its own event schema or can use a predefined one. Event schema can differ depending on the client application or activity the capture component is monitoring. Generally, the event schema can describe the format for an event, for example, by providing fields for event data associated with the event (such as the time of the event) and fields related to any associated article (such as the title) as well as the content of any associated article (such as the document body). An event schema can describe the format for any suitable event data that relates to an event. For example, an event schema for an instant messenger message event sent by the user 112a can include a recipient or list of recipients, the time sent, the date sent, content of the message, and a conversation ID. An event schema for a web page currently being viewed by a user can include the Uniform Resource Locator (URL) of the web page, the time being viewed, and the content of the web page. An event schema for a word processing document being saved by a user can include the title of the document, the time saved, the location of the document, the format of the document, the text of the document, and the location of the document. More generally, an event schema can describe the state of the system around the time of the event. For example, an event schema can contain a URL for a web page event associated with a previous web page that the user navigated from. In addition, event schema can describe fields with more complicated structure like lists. For example, an email schema can contain fields that list multiple recipients. An event schema can also contain optional fields so that an application can include additional event data if desired.

The capture processor 124 can capture events occurring presently (or “real-time events”) and can capture events that have occurred in the past (or “historical events”). Real-time events can be “indexable” or “non-indexable”. In one embodiment, the search engine 122 indexes indexable real-time events, but does not index non-indexable real-time events. The search engine 122 may determine whether to index an event based on the importance of the event. The importance may be measured by a capture score associated with and/or determined for the event. Indexable real-time events can be more important events associated with an article, such as viewing a web page, loading or saving a file, and receiving or sending an instant message or email. Non-indexable events can be deemed not important enough by the search engine 122 to index and store the event, such as moving the mouse or selecting a portion of text in an article. Non-indexable events can be used by the search engine 122 to update the current user state. While all real-time events can relate to what the user is currently doing (or the current user state), indexable real-time events can be indexed and stored in the data store 140. Alternatively, the search engine 122 can index all real-time events.

Real-time events can include, for example, sending or receiving an article, such as an instant messenger message, examining a portion of an article, such as selecting a portion of text or moving a mouse over a portion of a web page, changing an article, such as typing a word in an email message or pasting a sentence in a word processing document, closing an article, such as closing an instant messenger window or closing an email message window, loading, saving, opening, or viewing an article, such as a word processing document, web page, or email, listening to or saving an MP3 file or other audio/video file, or updating the metadata of an article, such as book marking a web page, printing a presentation document, deleting a word processing document, or moving a spreadsheet document.

Historical events are similar to indexable real-time events except that the event occurred before the installation of the search engine 122 or was otherwise not captured, because, for example, the search engine 122 was not operational for a period of time while the client device 102a was operational or because no capture component existed for a specific type of historical event at the time the event took place. Examples of historical events include the user's saved word processing documents, media files, presentation documents, calendar entries, and spreadsheet documents, the emails in a user's inbox, and the web pages book marked by the user. The capture processor 124 can capture historical events by periodically crawling the memory 108 and any associated data storage device for events not previously captured by the capture processor 124. The capture processor 124 can also capture historical events by requesting certain client applications, such as a web browser or an email application, to retrieve articles and other associated information. For example, the capture processor 124 can request that the web browser application obtain all viewed web pages by the user or request that the email application obtain all email messages associated with the user. These articles may not currently exist in memory 108 or on a storage device of the client device 102a. For example, the email application may have to retrieve emails from a server device. In one embodiment, the search engine 122 indexes historical events.

In the embodiment shown in FIG. 1, events captured by the capture processor 124 are sent to the queue 126 in a format described by an event schema. The capture processor 124 can also send performance data to the queue 126. Examples of performance data include current processor load, average processor load over a predetermined period of time, idle time, disk access, the client applications in use, and the amount of memory available. Performance data can also be provided by specific performance monitoring components, some of which may be part of the search engine 122, for example. The performance data in the queue 126 can be retrieved by the search engine 122 and the capture components of the capture processor 124. For example, capture components can retrieve the performance data to alter how many events are sent to the queue 126 or how detailed the events are that are sent (fewer or smaller events when the system is busy) or how frequently events are sent (events are sent less often when the system is busy or there are already too many events waiting to be processed). The search engine 122 can use performance data to determine when it indexes various events and when and how often it issues implicit queries.

In one embodiment, the queue 126 holds events until the search engine 122 is ready to process an event or events. Alternatively, the queue 126 uses the performance data to help determine how quickly to provide the events to the search engine 122. The queue 126 can comprise one or more separate queues including a user state queue and an index queue. The index queue can queue indexable events, for example. Alternatively, the queue 126 can have additional queues or comprise a single queue. The queue 126 can be implemented as a circular priority queue using memory mapped files. The queue can be a two- or three-priority queue where higher priority events are served before lower priority events, and other components may be able to specify the type of events they are interested in. Generally, real-time events can be given higher priority than historical events, and indexable events can be given higher priority than non-indexable real-time events. Other implementations of the queue 126 are possible. In another embodiment, the client device 102a does not have a queue 126. In this embodiment, events are passed directly from the capture processor 124 to the search engine 122. In other embodiments, events can be transferred between the capture components and the search engine using suitable information exchange mechanisms such as: Extensible Markup Language—Remote Procedure Calling protocol (XML/RPC), Hypertext Transfer Protocol (HTTP), Simple Object Access Protocol (SOAP), shared memory, sockets, local or remote procedure calling, or any other suitable information exchange mechanism.

The search engine 122 can contain an indexer 130, a query system 132, and a formatter 134. The query system 132 can retrieve all real-time events and performance data from the queue 126. The query system 132 can use performance data and real-time events to update the current user state and generate an implicit query. The query system 132 can also receive and process explicit queries from the user 112a. Performance data can also be retrieved by to the search engine 122 from the queue 126 for use in determining the amount of activity possible by the search engine 122.

In the embodiment shown in FIG. 1, indexable real-time events and historical events (indexable events) are retrieved from the queue 126 by the indexer 130. Alternatively, the queue 126 may send the indexable events to the indexer 130. The indexer 130 can index the indexable events and can send them to the data store 140 where they are stored. The data store 140 can be any type of computer-readable media and can be integrated with the client device 102a, such as a hard drive, or external to the client device 102a, such as an external hard drive or on another data storage device accessed through the network 106. In one embodiment, the data store 140 can be in memory 108. The data store 140 may facilitate one or combination of methods for storing data, including without limitation, arrays, hash tables, lists, and pairs, and may include compression and encryption. In the embodiment shown in FIG. 1, the data store comprises an index 142, a database 144 and a repository 146. The data store 140 comprises a local index. The local index in the embodiment shown in FIG. 1 may comprise information, such as articles, which are associated with the client device 102a, a user 112a of the client device 102a, or a group of users of the client device 102a. For example, the local index in the data store 140 shown in FIG. 1 may comprise an index of articles created, edited, received, or stored by the client user 112a using the client machine 102a, or articles otherwise associated with the client user 102a or the client machine 112a. The local index may be stored in a client machine, such as in data store 140, in a data store on a local network in a manner accessible by the client machine, on a server accessible to the client machine through the Internet, or in another accessible location.

In contrast, a global index may comprise information relevant to many users or many servers, such as, for example, an index of web pages located on multiple servers in communication with the World Wide Web. One example of a global index is an index used by the Google™ search engine to provide search results in response to a search query.

A single index may comprise both a local and a global index. For example, in one embodiment, an index may comprise both local and global information, and include a user or client identifier with the local information so that it may be identified with the user(s) or client(s) to which it pertains. Moreover, an index, local or global, may be present in one or multiple logical or physical locations.

In the embodiment shown in FIG. 1, when the indexer 130 receives an event, the indexer 130 can determine, from the event schema, terms (if any) associated with the event, the time of the event (if available), images (if any) associated with the event, and/or other information defining the event. The indexer 130 can also determine if the event relates to other events and associate the event with related events. For example, for a received instant messenger message event, the indexer can associate the message event with other message events from the same conversation. The messages from the same conversation can be associated with each other in a conversation object, which can be stored in the data store 140.

The indexer 130 can send and incorporate the terms and times, associated with the event in the index 142 of the data store 140. The event can be sent to the database 144 for storage and the content of the associated article and any associated images can be stored in the repository 146. The conversation object associated with instant messenger messages can be stored in the database 144.

In the embodiment shown in FIG. 1, a user 112a can input an explicit query into a search engine interface displayed on the client device 102a, which is received by the search engine 122. The search engine 122 can also generate an implicit query based on a current user state, which can be determined by the query system 132 from real-time events. Based on the query, the query system 132 can locate relevant information in the data store 140 and provide a result set. In one embodiment, the result set comprises article identifiers for articles associated with the client applications 120 or client articles. Client articles include articles associated with the user 112a or client device 102a, such as the user's emails, word processing documents, instant messenger messages, previously viewed web pages and any other article or portion of an article associated with the client device 102a or user 112a. An article identifier may be, for example, a Uniform Resource Locator (URL), a file name, a link, an icon, a path for a local file, or other information that may identify an article. In another embodiment, the result set also comprises article identifiers for articles located on the network 106 or network articles located by a search engine on a server device. Network articles include articles located on the network 106 not previously viewed or otherwise referenced by the user 112a, such as web pages not previously viewed by the user 112a.

Articles stored in the messaging index 142 can include one or more types of messages, such as a user's emails, chat messages, and instant messaging messages. Each time a message is received, sent, modified, printed, or otherwise accessed, a record may be stored in the messaging index 142. This information can later be searched to identify messages that should be displayed in the user interface.

An embodiment of the present invention may also store message threads in the data store 140. In such an embodiment, messages are related together by various attributes, including, for example, the sender, recipient, date/time sent and received, the subject, the content, the window identifier of the display window in which the messages were displayed, or any other attribute of the message. The related messages can then be retrieved as a thread, which may be treated as a document by the display processor 128.

The formatter 134 can receive the search result set from the query system 132 of the search engine 122 and can format the results for output to a display processor 128. In one embodiment, the formatter 134 can format the results in XML, HTML, or tab delineated text. In another embodiment, the formatter 134 displays the results as strings on user interface (UI) components such as labels. The display processor 128 can be contained in memory 108 and can control the display of the result set on a display device associated with the client device 102a. The display processor 128 may comprise various components. For example, in one embodiment, the display processor 128 comprises a Hypertext Transfer Protocol (HTTP) server that receives requests for information and responds by constructing and transmitting Hypertext Markup Language (HTML) pages. In one such embodiment, the HTTP server comprises a scaled-down version of the Apache Web server. The display processor 128 can be associated with a set of Application Programming Interfaces (API) to allow various applications to receive the results and display them in various formats. The display APIs can be implemented in various ways, including, for example, DLL exports, COM interface, VB, JAVA, or .NET libraries, or as a web service.

Through the client devices 102a-n, users 112a-n can communicate over the network 106, with each other and with other systems and devices coupled to the network 106. As shown in FIG. 1, a server device 150 can be coupled to the network 106. In the embodiment shown in FIG. 1, the search engine 122 can transmit a search query comprised of an explicit or implicit query or both to the server device 150. The user 112a can also enter a search query in a search engine interface, which can be transmitted to the server device 150 by the client device 102a via the network 106. In another embodiment, the query signal may instead be sent to a proxy server (not shown), which then transmits the query signal to server device 150. Other configurations are also possible.

The server device 150 can include a server executing a search engine application program, such as the Google™ search engine. In other embodiments, the server device 150 can comprise a related information server or an advertising server. Similar to the client devices 102a-n, the server device 150 can include a processor 160 coupled to a computer-readable memory 162. Server device 150, depicted as a single computer system, may be implemented as a network of computer processors. Examples of a server device 150 are servers, mainframe computers, networked computers, a processor-based device, and similar types of systems and devices. The server processor 160 can be any of a number of computer processors, such as processors from Intel Corporation of Santa Clara, Calif. and Motorola Corporation of Schaumburg, Ill. In another embodiment, the server device 150 may exist on a client-device. In still another embodiment, there can be multiple server devices 150.

Memory 162 contains the search engine application program, also known as a search engine 170. The search engine 170 can locate relevant information from the network 106 in response to a search query from a client device 102a. The search engine 170 then can provide a result set to the client device 102a via the network 106. The result set can comprise one or more article identifiers. An article identifier may be, for example, a Uniform Resource Locator (URL), a file name, a link, an icon, a path for a local file, or anything else that identifies an article. In one embodiment, an article identifier can comprise a URL associated with an article.

In one embodiment, the server device 150, or related device, has previously performed a crawl of the network 106 to locate articles, such as web pages, stored at other devices or systems coupled to the network 106, and indexed the articles in memory 162 or on another data storage device. It should be appreciated that other methods for indexing articles in lieu of or in combination with crawling may be used, such as manual submission.

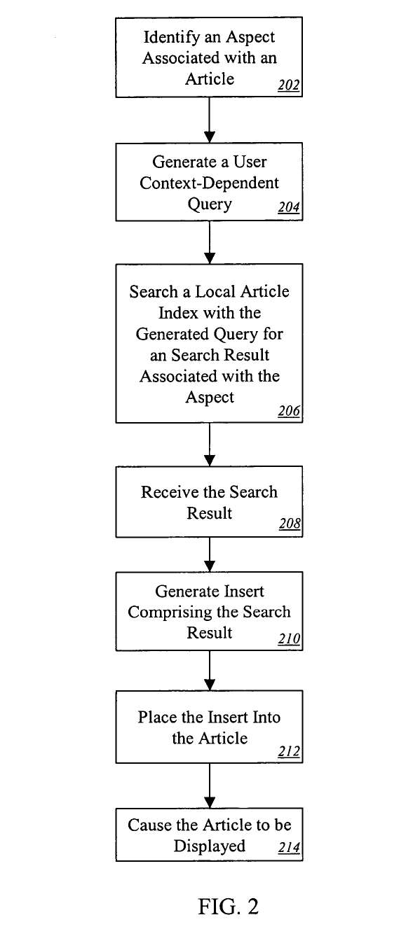

It should be noted that other embodiments of the present invention may comprise systems having different architecture than that which is shown in FIG. 1. For example, in some other embodiments of the present invention, the client device 102a is a stand-alone device and is not coupled to a network. The system 100 shown in FIG. 1 is merely exemplary, and is used to explain the exemplary methods shown in FIGS. 2 through 7.

### Process

Various methods may be implemented in the environment shown in FIG. 1 and other environments, according to the present invention. Methods according to the present invention may be implemented by, for example, a processor-executable program code stored on a computer-readable medium.

For example, in one embodiment of the present invention, a method is provided that comprises identifying an aspect associated with an article, generating an insert, and causing the insert to be output in association with the aspect. The generation of the insert may be based, at least in part, on the aspect, and the generated insert may comprise a search result. The search result may comprise at least one of an article identifier, a thumbnail, a text snippet, a Uniform Resource Locator, and a path.

An aspect may comprise an aspect of an article. An aspect associated with an article, for example, may comprise a hyperlink contained in a web page article; an image or sound file associated with or contained in an article; a citation in a text document; a menu or a particular menu item found in a web page; a caption; a status bar; a web counter associated with a web page article; a name, email address, or screen name of a sender or a recipient of an email or instant messenger message; a recipient input field or a subject input field of an email message; a domain name; information about an article's author or publisher; a prominent term or feature of an article; a table or a figure in a word-processor document; an entry, a column title, or a formula in a spreadsheet article; a slide or a slide title in a presentation article; source data; a Uniform Resource Locator (URL); article meta data; a JavaScript program contained in an Hypertext Transfer Protocol (HTTP) or Hypertext Markup Language (HTML) article; an article header; a window identifier in which an article is displayed; a conversation identifier; a roster list of participants in an instant messenger conversation; an article's title; and an input field contained in an article.

Generation of an insert may comprise searching an article index for a search result. In one embodiment, the article index searched may comprise an index of articles available on the World Wide Web. For example, one such article index may comprise information related to a plurality of web page articles found by a web crawler or other index building mechanism and organized such that it is searchable upon receiving a search query. In another embodiment, the article index searched may comprise a local article index. For example, a local article index may comprise the article index 143. In one embodiment, the local article index may comprise a messaging index, such as the messaging index 142 described with respect to FIG. 1, and/or other indexes associated with a client device or application.

Searching an article index for a search result to be included in the insert may comprise generating a user context-dependent search query to use in searching the article index. A user context-dependent search query may be based, at least in part, on a user action history comprising a plurality of user actions.

In another embodiment of the present invention, a method may comprise identifying an aspect associated with an article, automatically generating an insert comprising a request, and causing the insert to be output in association with the aspect. The generation of the insert may be based, at least in part, on the aspect. The request may comprise a request to the user 112a. For example, the request may comprise an article-related request. An article-related request may comprise a request associated with actions the client device 102a may take associated with the article comprising the aspect. For example, a request may comprise a request to the user for information, a permission, a direction, an instruction, a decision, an answer, and/or a prioritization. For example, a request for permission may comprise a request for permission to index information and events associated with the article comprising the aspect. A request for a prioritization may comprise a request to the user 112a to indicate the relative priority events related to the presently-viewed article, where higher priority events may be more quickly accessed later in a search of a local article index.

A request included in an insert may comprise a user context-dependent request. In one such embodiment, generating the insert may comprise generating a user context-dependent request. A user context-dependent request may be based, at least in part, on a user action history comprising a plurality of user actions.

An insert generated according to the present invention may be caused to be output in association with the aspect in a wide variety of different methods in different embodiments. For example, in one embodiment, at least part of the insert may be placed into the article comprising the aspect. In another embodiment, at least part of the insert may be caused to be displayed in a transient display proximate to the aspect. In yet another embodiment, at least part of the insert may be caused to be displayed in a separate window from the article, such as a pop-up window. Those skilled in the art will recognize yet other ways of outputting the insert in association with an aspect.

In one embodiment of the present invention, a processor may 110 receive an article comprising an aspect. For instance, the article may comprise a web page, and the aspect may comprise a hyperlink found on the web page article. The processor 110 may then analyze the article. For example, in one embodiment, the processor may analyze the article for the presence of an aspect, such as a hyperlink, or an image. Upon identifying an aspect associated with the article, the search engine 122 may then automatically search an article index for a search result, such as an article identifier, associated with the aspect.

In one embodiment, the search function may search a local article index, such as the article index 143 shown in FIG. 1. For example, the local article index may comprise a plurality of Uniform Resource Locator (URL) article identifiers, and the search engine 122 may search the article index 143 or another area of the data store 140, for a URL article identifier associated with the hyperlink aspect found on a web page article. The search engine 122 may also search the article index 143 for an article associated with all or a majority of the article's content. In one embodiment, the search engine 122 may search a local article index for a one or more search results associated with the aspect of the article. In another embodiment, the search engine 122 may search an index of articles available on the world wide web, such as by communicating with the search engine 170.

The generation of the insert may be based, at least in part, on the aspect. For example, the processor 110, or another suitable entity may generate an association of the aspect with a search result and/or a request. The association may comprise more than a one-to-one relationship between a particular search result and/or request and a particular aspect. The association may have been previously undetermined before the processor 110 associates the applicable search result and/or request with the aspect. The association may comprise a wide variety of connections, relations, unions, overlaps, links, combinations, affiliations, similarities, tie-ins, and commonalities between the aspect and the search result and/or the request. Just some examples of associations between a search result and/or a request and an aspect may include commonality of text, related publishers or authors, and similar subject matter. A search result may comprise a variety of other forms and formats, including an article identifier, a text snippet excerpted from or summarizing the article it is associated with; a thumbnail, such as a thumbnail image contained in the article the article identifier is associated with; and a path, such as a Microsoft® PowerPoint presentation file name.

A search of an article index, such as a local article index, for a search result associated with the aspect of the article may be triggered by a variety of stimuli. For example, the search may be triggered by an opening of an application on the client device 102a, by hovering an indicator on a user interface corresponding to a pointing device over the aspect, by clicking on the aspect, by typing text in the article, by clicking on a term, or by clicking on or hovering over a term receptacle such as an address bar.

In this method, the display processor 128 may then generate an insert comprising at least one of a search result and a request. An exemplary insert may comprise a URL article identifier search result and a request for an input from the user 112a related to the article comprising the aspect. For instance, the request for an input from the user 112a may comprise a request for an instruction whether to archive events related to the article comprising the aspect. The display processor 128 may then cause the insert to be output in association with the aspect. For example, in one embodiment, the display processor 128 may modify the article by placing at least a part of the insert into the article in association with the aspect. In one embodiment, the insert may be caused to be output in association with the aspect by generating and causing the output of a transient display proximate to the aspect. The transient display proximate to the aspect may comprise a transient menu. For example, a transient display proximate to the aspect may comprise a drop-down menu near a hyperlink aspect contained in the article. A transient display insert may alternatively comprise a Microsoft® windows tool-tip proximate to the aspect, and may be programmed to appear only when the user 112a hovers an indicator on a user interface device corresponding to a mouse over the aspect. In yet another embodiment, the insert may be caused to be output in association with the aspect by integrating the insert into the aspect of the article. In one such embodiment, an article comprising text, for example, may be modified by moving text found below the aspect downward on the document, and placing an insert, such as a thumbnail image search result in the newly created space formerly occupied by article text. Of course, those skilled in the art will appreciate from the foregoing description of exemplary embodiments that the insert may be integrated into or output in association with the aspect in a number of other ways in other embodiments of the invention.

The display processor 128 may then cause the modified article to be output. For example, the modified article to be output to a user interface device, such as a computer monitor, for the user 112a to view. In one embodiment, the modified article is caused to be output upon receipt of an interest signal. For example, the user 112a may generate and output to the client device 102a an interest signal comprising his or her interest in the aspect of the article. For instance, the user 112a may generate an interest signal by hovering an indicator corresponding to a pointing device, such as a mouse, over a hyperlink on a web page.

The article may comprise existing data in a first article format, such as HTML, and the insert may comprise client device-generated data in the same first article format. In such an embodiment, placing the insert into the article can comprise adding the client device-generated HTML data to the article's existing HTML. In a different embodiment, the article may comprise existing data in the first article format, and the insert may comprise client device-generated data in a second article format. For instance, the insert may comprise JavaScript program code, and may be placed into a Microsoft® Word article.

In one embodiment, a search query the search engine 122 may execute against an article index may comprise a user context-dependent search query generated by the client device 102a. In another embodiment, an insert may comprise a user context-dependent request. The context in which the user 112a is operating may be determined based on the client applications 120 that the user 112a is executing, the content of the files on which the user 112a is operating, or other activity or event(s) occurring on the client 102a. The user context may comprise, for example, a user action history comprising a plurality of user actions. Each user action comprises various parameters, including, for example, a date/time parameter. For example, if the user 112a prints a word-processing document multiple times in a short period of time, the queries against a messaging and/or an article index may be related to the content of the document the user 112a printed, the recentness and/or the frequency of activity related to the document. Similarly, a user context-dependent request output to the user 112a in an insert may comprise a request for permission to archive future events associated with the previously printed word-processing document.

User context-dependent requests and search queries may be generated using information from a user's actions or a combination thereof. One such user context-dependent search query may be generated by the query system 132 or another suitable entity. For example, if the user 112a prints a word-processing document and also highlights an aspect comprising a selection of words within that document, the queries generated may be a combination of content from the entire printed document and the highlighted words. A user-context dependent request may request of the user 112a whether he or she wishes to search for articles related to the highlighted aspect. In another embodiment, a user context-dependent search query or request may be generated based upon which email messages the user 112a has recently accessed, or upon an email organization structure the user 112a maintains in an email application. Activities or actions taken by the user 112a while browsing websites on an information network, such as the Internet, may also be used to generate a user context-dependent search query and/or a user-context dependent request.

An article index searched for a search result may comprise differing types of indices in different embodiments. For example, in one embodiment, a local article index may be searched. In one such embodiment, a local article index may comprise a messaging index. The messaging index 142 may comprise at least one of a chat message identifier, an email message identifier, an instant message identifier, or other messaging article. The messaging index 142 may comprise article identifiers for any messaging-related articles. Indices other than an article or messaging index may also be utilized.

For example, in one embodiment, if a user 112a is editing an article comprising a title aspect, and types the term “laptop” into the title aspect, the display processor 128 may receive a search result set from the messaging index that includes article identifiers in the messaging index 142 that are relevant, as determined by the search engine 122, to the term “laptop.” A generated insert may comprise links to email threads, chat messages, instant messages, and other messaging articles. The display processor 128 may additionally or alternatively receive one or more search results from an article index in response to a search query. For example, the display processor 128 may receive a search result set that includes search results retrieved from an article index, such as the article index 143 that are relevant to the aspect, as determined by the search engine 122, to the term “laptop.” The article index 143 may include, for example, an index of word-processor documents, and the search results may include links to the documents.

In such an embodiment, the display processor 128 may then automatically generate an insert based, at least in part, on the aspect, and comprising at least one of a search result, and a request. The display processor may, for example, generate an HTML insert or other document that may be viewed in a browser, the insert including one or both of a search result and a request so that the user 112a can easily access an article associated with the search result and/or instruct the client device 102a to capture events related to the article presently being viewed.

A different method according to the present invention comprises receiving a term in an input field. For example, the term may comprise a word or phrase entered into an address bar of a network browser application, such as Microsoft's Internet Explorer® web browser application, and the entered term may be received by the search engine 122. In other embodiments, the input field may comprise other address bars, as well as other term receptacles, such as a query-input field, such as the query input field found in Google Corporation's Google Toolbar product. In an email application, the input field may comprise a “To:” box provided to input a recipient's name. In yet other embodiments, the input field may comprise an article-integrated input field. Examples of an article-integrated input field comprise a text box, as commonly found on a variety of web pages available on the Internet.

This method further comprises searching an article index for an article identifier associated with the received term. In one embodiment, the search engine 122 may perform the search. In one such embodiment, the article index may comprise an index on the client device 102a, such as the article index 143, or the messaging index 142. In another embodiment, the article index may comprise an index maintained by a server device of web page articles available on an information network, such as the Internet. An example of such an index is the index maintained by a search engine 170 pictured in FIG. 1. The search engine 170 may comprise, for instance, the Google search engine. One embodiment further comprises searching a second article index for a second article identifier associated with the received term. The second article identifier may be associated with a second article associated with the term.

This method further comprises receiving the article identifier, and causing it to be output in a transient menu associated with the input field. In one embodiment, the display processor 128 receives the article identifier and causes it to be output in the transient menu associated with the input field. The transient menu may take a variety of forms. For instance, in one embodiment, the transient menu may comprise a drop-down menu near, or otherwise proximate to or associated with, the input field. In other embodiments, the transient menu may comprise other suitable forms, such as a pop-up menu near the input field, a slide-out menu near the input field, a separate window, a pop-up menu that covers or surrounds the input field, and a tool-tip substantially near the input field.

The article identifier may be associated with an article. For example, the article identifier may comprise a URL or other path associated with a web page article that pertains to the received term. In other embodiments, the article identifier may comprise other forms and formats. For example, the article identifier may comprise a path, such as a Microsoft® Excel file name. In another embodiment, the article identifier may comprise a creator name associated with a creator of the article. For instance, the creator name may comprise the author or publisher of a web page, the author or publisher of a word-processor document, or the author or publisher of an email or instant messenger message. The article identifier may alternatively comprise a snippet. For example, the snippet may comprise an excerpt or a summary of the article. In another embodiment, the article identifier may comprise a thumbnail, such as a thumbnail image excerpted from the article. The article identifier may also comprise a message thread, for instance, a message thread that relates a plurality of related email messages.

In one embodiment, a search query the search engine 122 executes against the local article index may be a user context-dependent search query generated by the client device 102a. The context in which the user 112a is operating may be determined, for example, based on the client applications 120 that the user 112a is executing, the content of the files on which the user 112a is operating, or other activity or event(s) occurring on the client 102a. The user context may comprise, for example, a user action history comprising a plurality of user actions. Each user action comprises various parameters, including, for example, a date/time parameter. For example, if the user 112a prints a word-processing document multiple times in a short period of time, the queries against the messaging and article indices may be related to the content of the document the user 112a printed.

One embodiment further comprises receiving a select indication for the article identifier, and displaying an article associated with the article identifier. For example, in one such embodiment, the display processor 128 may receive the select indication from the user 112a, indicating that he or she is interested in seeing the article associated with the article identifier output to the user 112a. The display processor 128 may then retrieve the article from the data store 140, and output the article to the user 112a. The article identifier may be a URL in such an embodiment, and the article associated with the URL article identifier may be a web page article. The web page article may be output to the user 112a by displaying the web page article on a graphical user interface in communication with the client device 102a.

A server device, such as the server device 104, may carry out another method according to the present invention. This method comprises receiving a term signal comprising a term, such as the one of the types of terms described above, and searching an article index for an article identifier associated with the term and an article that pertains to the term. The article index may comprise, for example, a server-based messaging index or a server-based article index, or the search engine 170 pictured in FIG. 1. The method further comprises retrieving the article identifier, and generating an information signal causing the article identifier to be output in a transient menu associated with an input field. One embodiment according to this method further comprises outputting the generated information signal to a client device, such as the client device 102a.

As with the other methods according to the present invention, a search query the search engine 122 executes against the local article index may be a user context-dependent search query generated by the client device 102a. The context in which the user 112a is operating may be determined based on the client applications 120 that the user 112a is executing, the content of the files on which the user 112a is operating, or other activity or event(s) occurring on the client 102a. The user context may comprise, for example, a user action history comprising a plurality of user actions. Each user action comprises various parameters, including, for example, a date/time parameter. For example, if the user 112a prints a word-processing document multiple times in a short period of time, the queries against the messaging and article indices may be related to the content of the document the user 112a printed.

FIG. 2 is a flowchart illustrating generating a user interface in a first embodiment of the present invention. In the embodiment shown, the client device 102a identifies an aspect associated with an article as shown by box 202. The aspect may comprise a hyperlink contained in the web page article. Other examples of aspects comprise images in an article, article headers, audio files in an article, article titles, email recipients' names, and input fields contained in an article.

As shown by box 204, upon identifying the aspect, the query system 132 generates a user context-dependent query. The user context-dependent query may be an implicit query generated by a client application 120 in response to events associated with the user 112a, for example, information being entered by or output to the user 112a. For example, the response to the query may depend on the time of day the query is run or on previous or a sequence of previous actions by the user. In one embodiment, the current user context is derived from a data store comprising a history of user actions, such as printing or opening a file, or sending an email message. In other embodiments, the query generated may be an explicit query, e.g., a query entered by a user 112a in a text box or other user input interface.

Upon generating the user context-dependent query, the query system 132 executes the generated search query on a local article index, such as the article index 143 stored in the data store (140) 206. The query system 132 searches the local article index for a search result, such as an article identifier, associated with the aspect. An exemplary search result may comprise a path of a word-processing document stored on the client device 102a, where the document is associated with the aspect. The query system 132 then receives the search result from the local article index as shown by box 208. The search result may comprise one or more article identifiers, and may comprise snippets or text summaries of the article with which the article identifier is associated. In the case of a file, the search result may be a fully qualified path.

In one embodiment, the query system 132 may then rank a plurality of search results in the result set. The query system 132 may perform queries on additional indices, such as the messaging index 142, or an index comprising news articles, or any other type of document or file that can be indexed. The query system 132 may also cause queries to be executed on indices not stored on the client 102a or in the data store 140. For example, in one embodiment, the query system 132 may cause queries to be executed on the search engine 170.

In the embodiment shown, the query system 132 outputs the result set to the display processor 128, which generates an insert as shown by box 210. The insert may be based, at least in part, on the aspect, and may comprise the search result. The insert may comprise an HTML coding of information such as text describing the search result, a thumbnail image of the article, or any other information that would be useful to the user 112a in identifying a potentially relevant result. The insert may alternatively or additionally comprise a request. A request may comprise an article-related request, and may comprise a user context-dependent request. A request may comprise, for example a request to the user 112a to indicate whether the indexer 130 should index events pertaining to the presently viewed web page article. In another embodiment, a request may comprise another request for information or for a decision from the user 112a, such as whether an event should be marked as high-priority, whether the user 112a would like to see more articles like the one he or she is presently accessing, whether the user would like to add a bookmark on his or her desktop to the article, whether the user would like to return to the last article he or she had accessed, whether articles received from the same author or publisher should be automatically output to the user 112a, etc.

In the embodiment shown in FIG. 2, the display processor 128 then places the insert into the article in association with the aspect as shown by box 212. For example, the display processor 128 may modify a web page article by placing an HTML insert into the existing HTML of the web page article such that the insert will be displayed near the aspect when the article is displayed. In one embodiment, an effect of this modification of the article may comprise a displacement or a movement of existing article content or of the aspect, and the inclusion of the insert's content. The display processor 128 may then cause the article to be displayed or otherwise output as shown in box 214. In one embodiment, the display processor 128 may cause the article comprising the insert to be displayed on a graphical user interface in communication with the client device 102a. The functions described may be performed by other components in another embodiment of the present invention. For example, in one embodiment, the query system 132 and display processor 128 are combined, and the combined component performs functions to facilitate execution of queries, ranking of result sets, and causing the outputting of the insert and article. Other configurations are also possible.

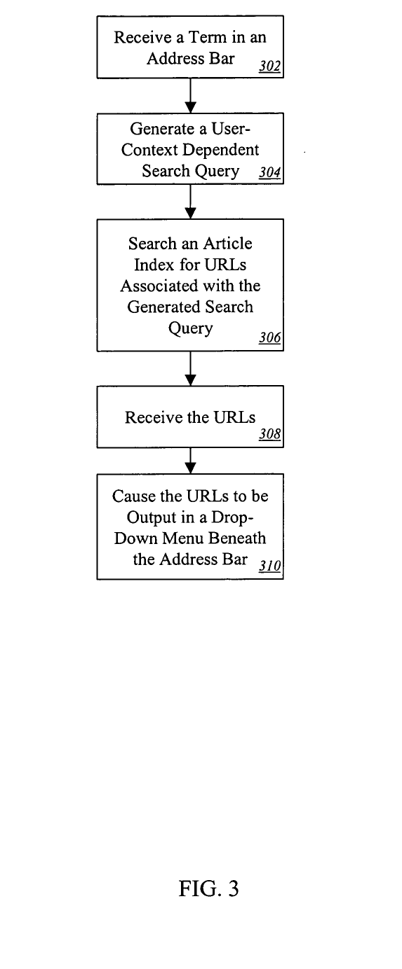

FIG. 3 is a flowchart illustrating generating a user interface in a second embodiment of the present invention. First, a client application 120 receives a term in an address bar input field 302. For example, the client application 120 may comprise a network browser application, such as Microsoft's Internet Explorer®. Such a client application may include an address bar input field, where a user 112a may enter in a URL of a website that they may wish to visit on the Internet. In other embodiments, the client application 120 may comprise a different suitable type, such as an email program, and the input field may comprise a term receptacle for inputting an email recipient's name or email address. The term received by the address bar input field may comprise a full term, such as a full word, phrase, or sentence, or may comprise a partial term, such as a misspelled word, a partial word lacking a suffix or a prefix, an incomplete phrase, or a fragment sentence.

The client application 120 outputs information conveying the received term to the search engine 122. The query system 132 of the search engine 122 may then generate a user-context dependent search query 304 associated with the user 112a and the term received in the address bar. The user context-dependent query 304 may be an implicit query generated by a client application 120 in response to events associated with the user 112a, for example, information being entered by or output to the user 112a. For example, the response to the query may depend on the time of day the query is run or on previous or a sequence of previous actions by the user. In one embodiment, the current user context is derived from a data store 140 comprising a history of user actions, such as printing or opening a file, or sending an email message. In other embodiments, the query generated may be an explicit query, e.g., a query entered by a user 112a in a text box, or a query term input in an input field, such as the term received in the address bar input field in 302.

In the embodiment shown in FIG. 3, the search engine 122 may then search an article index, such as a local article index 143 or a local messaging index 142, for URLs associated with the generated query. Alternatively or additionally, an embodiment may search an article index for other types of article identifiers, such as file names or paths, thumbnail images, sound files, or text snippets. In one embodiment, the search engine 122 may generate and output a term signal to a server device comprising a second article index, the term signal to instruct the server device to search for a second article identifier associated with a second article and the term. In some embodiments, the search engine 122 may output the generated search query over the network 106 to a search engine 170. In such an embodiment, the search engine 170 may search the network 106 for URLs or other article identifiers associated with the search query.

Upon finding URLs associated with the generated search query, the search engine 122 outputs the URLs to the display processor 128. The display processor 128 then receives the URLs 308. The display processor 128 then causes the received URLs to be output to a graphical user interface in a drop-down transient menu near the address bar input field 310. In other embodiments, received URLs or other article identifiers associated with the received term or the generated query may be output in other forms of transient menus associated with the address bar or another suitable input field. For example, a text snippet article identifier may be caused to be output as a transient tool-tip located substantially near the input field. In one embodiment, other information that the user 112a may find useful or informative is provided along with the article identifiers associated with the received term in the transient menu. For example, information pertaining to when the user 112a last visited an article associated with a provided article identifier, when the user 112a last entered the term in the term receptacle, or similar queries the user 112a may find helpful to achieving his or her search or navigational goals may be provided along with an article identifier associated with the received term.

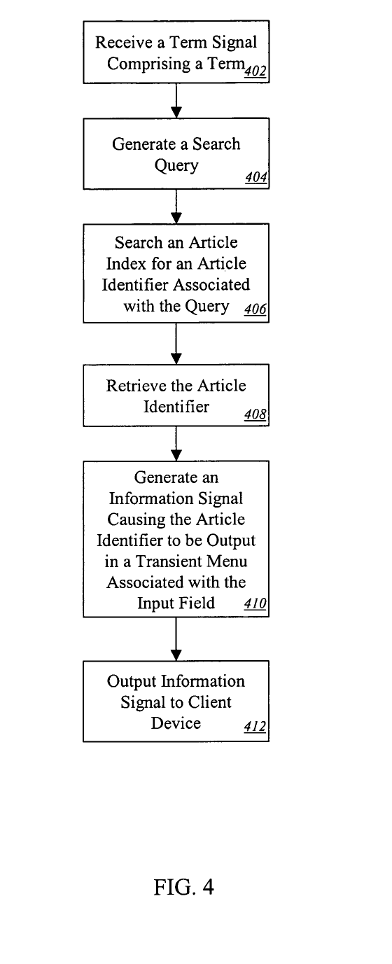

FIG. 4 is a flowchart illustrating generating a user interface in a third embodiment of the present invention. In the embodiment shown, a server device, such as the server device 150 shown in FIG. 1, receives a term signal comprising a term 402. The term in such an embodiment may have been input by a user of a client device in an input field, such as an address bar of a web browser client application. For instance, the term signal may have been generated by a client device search function, such as the search engine 122 shown in FIG. 1, and output over the network 106 to the server device 150. In another embodiment, a client device that receives a term in an input field may search a local article index for article identifiers associated with the term, either in addition to, or alternatively to, outputting a term signal to the server device 150.

Upon receiving the term signal, the server device may output the term to a search engine application contained in the server device's memory. The search engine application may be, for example, the search engine 170 contained in the memory 162 of the server device 150 shown in FIG. 1. The search engine 170 then generates a search query associated with the term 404. The search query may comprise a user-context dependent search query associated with a user and the term received. The user context-dependent query may be an implicit query generated by a client application 120 in response to events associated with the user 112a, for example, information being entered by or output to the user 112a via the client device 102a. For example, the response to the query may depend on the time of day the query is run or on previous or a sequence of previous actions by the user. In one embodiment, the current user context is derived from a data store in communication with the server device 150 that comprises a history of user actions, such as printing or opening a file, or sending an email message. In other embodiments, the query generated may be an explicit query, e.g., a query derived by the server device 150 solely from the term or terms received in the term signal.

The search engine 170 may then search an article index for an article identifier, such as a URL, associated with the generated search query 406. For instance, the search engine may search the Internet for a URL of a web page article that is associated with the interests indicated by the term or terms in the term signal. Upon finding such an article identifier, the search engine 170 may retrieve the article identifier 408.

The search engine 170 may then generate an information signal causing the retrieved article identifier to be output in a transient menu associated with an input field 410. For example, the information signal may cause a URL article identifier to be output on a graphical user interface in a drop-down menu near an address bar input field on a web browser client application. The server device 150 then outputs the information signal generated by the search engine 170 to a client device 412, such as the client device 102a shown in FIG. 1. The information signal may be output over the network 106. The client device 102a may then output the article identifier to the user 112a in accordance with the instructions contained in the information signal.

### EXAMPLES

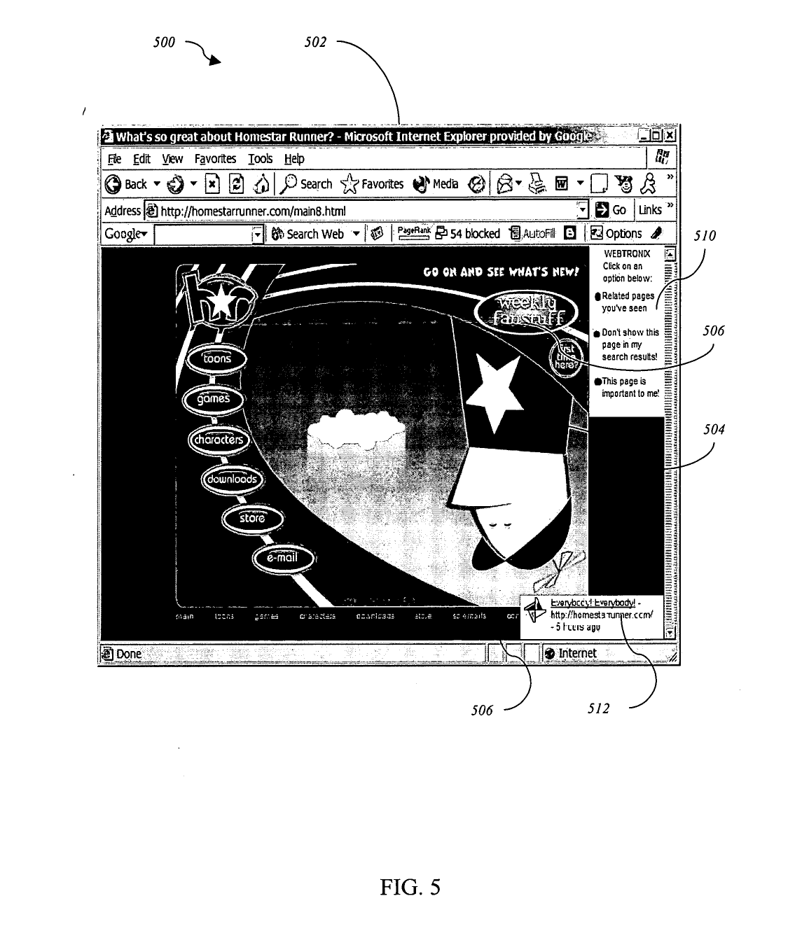

FIG. 5 is a screen shot 500 illustrating information displayed in an HTML web page article in one embodiment of an article constructed according to the method shown in FIG. 2. The screen shot 500 shows a web browser client application 502. The web browser client application 502 displays an HTML web page article 504 comprising aspects 506 and 508. First aspect 506 comprises a title aspect of the web page article 504. Aspect 508 comprises a baseline menu of areas related to the web page article 504 that a user could choose to investigate.

As shown in FIG. 5, the web page article 504 has been modified with the placement of inserts 510 and 512. The first insert 510 comprises a request output in association with the title first aspect 506. The request shown comprises article-related request. The request shown comprises a request to the user to select an option from among a list of three options related to the displayed web page article 504. The first option allows a user of the web browser client application 502 to see a list of related web page articles that he or she has already viewed. The second option allows the user to exclude the presently displayed web page article 504 from a client machine data store. The third option allows the user to flag the web page article 504 presently displayed as important, and possibly worth viewing again.

The second insert 512 comprises a search result, and has been output in association with the baseline menu second aspect 506 of the web page article 504. The search result shown in the second insert 512 comprises an article identifier. The second insert 512 shown comprises information about when the user of the client device web browser application 502 last visited the presently displayed website. The second insert 512 further comprises HTML generated by a display processor and integrated into the existing HTML of the web page article 504. In other embodiments inserts may comprise a wide variety of information, search results, article identifiers, and requests, and may take other forms, such as a transient display proximate to the aspect, such as a tool-tip or a transient menu, or may be displayed in a window separate from the article.

The two inserts 510, 512 and the layout of their placement in the web page article 504 shown in FIG. 5 are merely exemplary of how an HTML article may be modified according to the present invention. For example, a user 112a may select different, fewer, or additional categories to display on the HTML article. In one embodiment, the user 112a may access an administration page to vary the layout of the HTML article shown in FIG. 5 as desired.

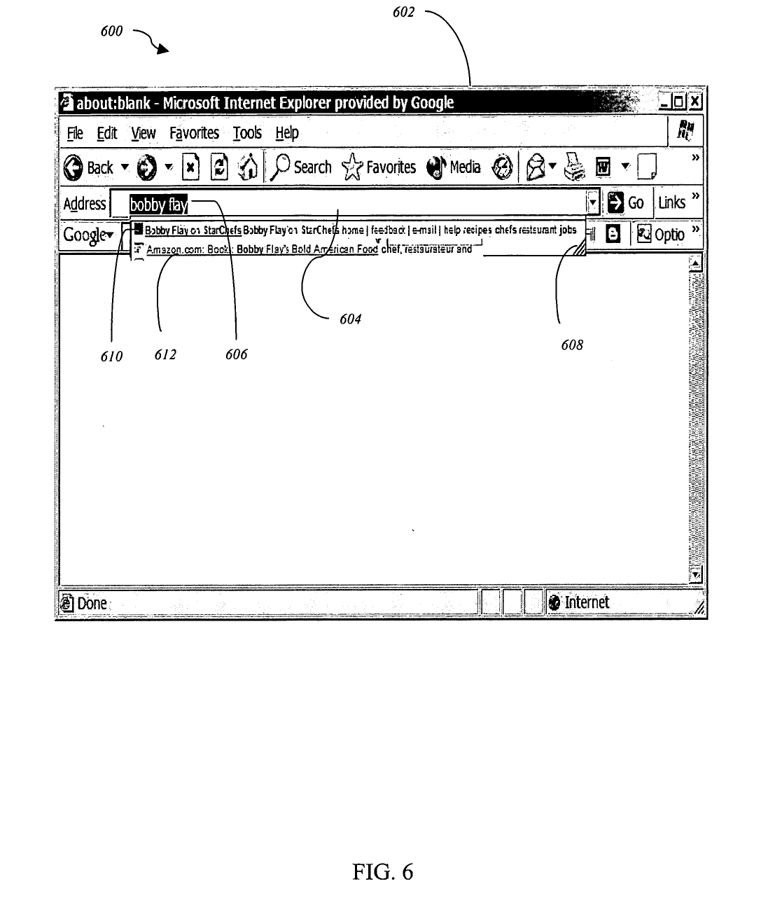

Another embodiment of the present invention may present an article identifier to a user in a transient menu associated with an input field. FIG. 6 is a screen shot 600 illustrating a user interface according to a second embodiment of the present invention. The screen shot 600 represents a graphical user interface generated according to the method shown in FIG. 3. The screen shot 600 shows a client application display 602. In the embodiment shown, the client application comprises a Microsoft® Internet Explorer® web browser application. The client application display 602 comprises an address bar 604. The address bar 604 may conventionally be used to input a URL of a web page article that a user wishes to visit on the Internet or an intranet. In the embodiment shown, the address bar 604 may be used to enter a term 606. The term 606 may comprise, for example, a word, a phrase, a sentence, or a query. In the embodiment shown, the term 606, “bobby flay,” has been entered in the address bar 604.

In the embodiment shown in FIG. 6, a transient drop-down menu 608 is shown near the address bar 604. In the embodiment shown, the transient drop-down menu 608 appears when a user of the web browser 602 enters a term 606 in the address bar 604, and disappears when the user either selects an item from the drop-down menu, or types a URL or other web address in the address bar 604. In other embodiments, the transient menu may disappear in response to a variety of stimuli. For example, the transient menu may disappear in response to the receipt of a predetermined term, substring, or characters, such as “http,” or “://” in the term receptacle may trigger the transient menu to disappear. In another embodiment, the transient menu may disappear momentarily as the user 112a enters more terms in the term receptacle, and may reappear after the system has performed a new search for article identifiers associated with the additional terms.

The drop-down menu 608 shown comprises two article identifiers 610, 612. The first article identifier 610 shown comprises a hyperlink to a web page article on a “StarChefs” website related to “Bobby Flay.” The first article identifier 610 further comprises a selection of hyperlinked menu items, each providing access to a different section on the “StarChefs” website related to “Bobby Flay.” The second article identifier 612 shown, comprises a hyperlink to a page on a retail site, “Amazon.com®,” that pertains to a book titled Bobby Flay's Bold American Food, and that is likely authored by “Bobby Flay.” Both the first and the second article identifiers 610, 612 shown comprise items stored in and retrieved from a local data store on a client device executing the web browser application 602. In other embodiments, article identifiers presented to a user may comprise a wide variety of suitable types, including thumbnail images, file names or paths, and may be items stored on and retrieved from a server device, or located by a search engine on a server device, such as the search engine 170 shown in FIG. 1.

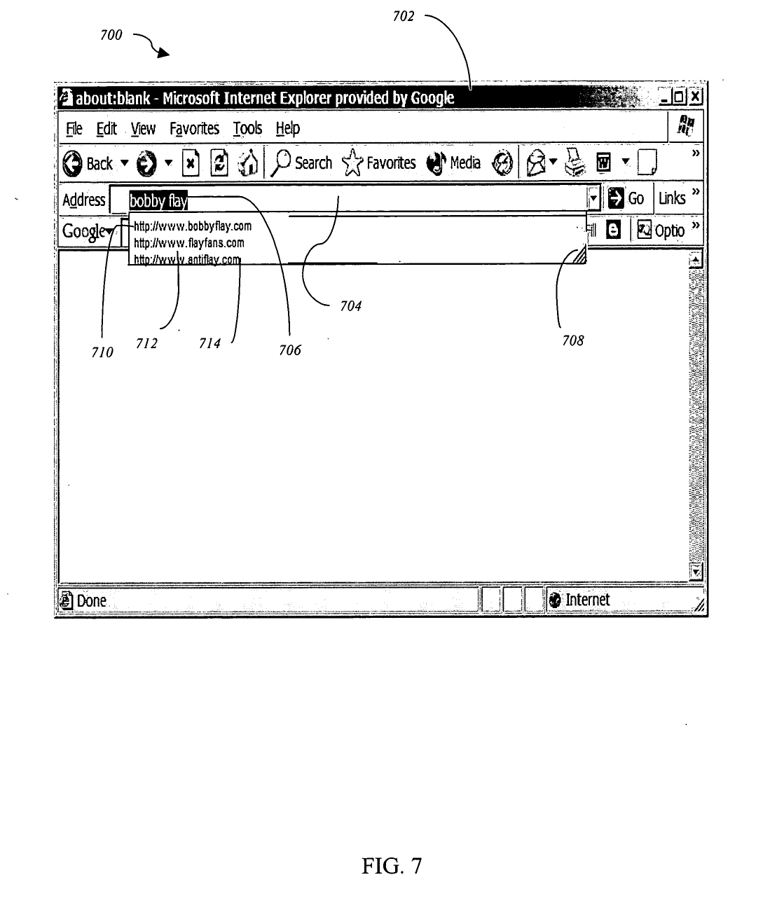

FIG. 7 is a screen shot 700 illustrating a user interface according to a third embodiment of the present invention. The screen shot 700 represents a graphical user interface generated according to the method shown in FIG. 4. The screen shot 700 shows a user interface of a web browser client application 702. The web browser client application shown is a Microsoft® Internet Explorer® web browser application. The web browser client application 702 comprises an address bar 704. The address bar 704 may be used similarly to the address bar (604) described with respect to FIG. 6. In the embodiment shown, a user has entered a term 706 into the address bar 704. The term 706 shown comprises “bobby flay.” In other embodiments, a variety of terms 706, such as those described above, may be entered into the address bar 704.

The screen shot 700 further comprises a drop-down transient menu 708 near the address bar 704. Other embodiments comprise various suitable transient menus associated with input fields. For example, in one embodiment, the transient menu may comprise a right-click menu that appears near an article-integrated input field when a user “right-clicks” the right mouse button while using a Microsoft® Windows® application. The transient menu 708 shown comprises three article identifiers 710, 712, and 714. The three article identifiers shown were found by a server device running a search engine application using a query generated in response to the input term 706 “bobby flay.” The article identifiers shown 710, 712, 714 each comprise an Internet address for a website that pertains to the term 706 entered in the address bar 704.

The transient drop-down menu 708 shown in FIG. 7 appears when a user types a term 706 in the address bar 704. The drop-down menu 708 disappears when the user enters a URL, website address, or file name in the address bar 704, or after a predetermined period of time. In the embodiment shown in FIG. 7, the resultant article identifiers 710, 712, 714 in the drop down menu 708 comprise results that may be conventionally presented to a user upon inputting the same or a similar search term in the query box of a search engine, such as the Google® search engine. The present embodiment allows the user to forgo traveling to a search engine to conduct a search, instead receiving results upon entering a term in the address bar of a web browser. The present embodiment may also allow the user 112a to forgo an explicit search action, such as typing a search query into a search box, that may be required in conventional methods in order to receive search results and execute a search action.

Embodiments of the present invention may incorporate additional features as well. For example, in one embodiment of the present invention, the display processor 128 supports a set of Application Programming Interface (API) calls. In this embodiment, an application running on the client 102a, such as the web server, is able to call an API to display information according to an embodiment of the present invention, such as those exemplary methods set out above. The API may also provide the capability of formatting the result set in HTML, XML, or any other format required by the user.

It can be seen that there are many possible types, configurations and contents of aspects, inserts, term input fields, transient menus, and a wide variety of different methods of displaying and otherwise outputting inserts and transient menus. For example, possible types of aspects may include URLs, links, recognized global entities such as names, organizations, and recent news topics, as well as recognized entities related to the current user, such as important or repetitive terms or phrases for the user, names or identifiers of people that the user communicates with, etc.

Inserts may comprise content comprising related information, URLs, links, search result information, links to local and global search results, and meta information about local and global search results. Meta information about local and global search results may comprise, for example, the number of results in a local index, article information such as whether an article has been viewed, how long ago the article was last accessed or viewed, the number of times an article has been accessed or viewed, the length of time a user spent viewing an article, etc.

In various embodiments, generated inserts may be displayed or otherwise output as text proximate to an aspect, text after an aspect, a thumbnail or other image proximate an aspect, text or a thumbnail near the article comprising the aspect, text or a thumbnail in a pop-up or persistent window separate from the aspect or the article comprising the aspect, etc. Similarly an article identifier associated with a term received in an input field and received in response to a search of an article index may be displayed or otherwise output as text proximate the input field, text after the input field, text in the input field, a thumbnail or other image proximate the input field, text or a thumbnail near an article comprising or otherwise associated with the input field, text or a thumbnail in a pop-up or persistent window separate from the input field, etc.

One embodiment of the present invention comprises an administration page. The user 112a may click on an icon that provides access to the administration page. In one such embodiment, the user may be able to set preferences for display, such as the location of a transient menu, an insert, minimum size of a window, a type of transient display proximate an aspect, transient menu, insert or window to be displayed, a type of content to include in an insert and/or a transient menu, and various other parameters that may or may not relate to display, such as refresh rate, etc.

In another embodiment of the present invention, a user that may not have time to perform extensive customization and input of his or her preferences may find it useful for a system to be automatically customized or customizable to accommodate the various preferences and/or practices of the user. For example, in one embodiment, an aspect may be identified based, at least in part on a user preference. Similarly, an insert may be generated, and/or caused to be output in association with an aspect based, at least in part, on a user preference. Another embodiment may comprise causing an article identifier to be output in a transient menu associated with an input field based, at least in part, on a user preference. In one embodiment, a user preference may be requested from the user 112a. For example, in one embodiment, an insert comprising a request to the user 112a may request an indication of how the user 112a prefers to have his or her inserts and/or article identifiers output, and/or what sorts of information the user 112a finds useful in an insert.

In one such embodiment employing the use of a user preference, one or more of the aspects, transient menu types, insert types, insert display types, and transient menu display types may be automatically set based on existing information about a user. For example, in one embodiment, news topic aspects may be used to automatically generate an insert only if the user is known to visit news sites regularly. In another embodiment, related Microsoft Word® document insert types may be used only if a user is known to use that application or if he or she has that application installed on his or her client device. In one embodiment, weights can be assigned to various types, configurations and contents of different aspects, inserts, term input fields, transient menus, and methods of displaying and otherwise outputting inserts and transient menus. In one such embodiment, the weights may be assigned based on existing information about the user. Existing information about the user may be obtained by performing a system analysis of a client device 102a associated with a user 112a. In one embodiment, a user preference may be determined based, at least in part, on a system analysis. For example, information about the user 112a may be obtained by a system analysis comprising crawling a storage device(s) to locate programs, files, and activities, and/or from examining operating system or application preferences, etc. For example, a system analysis of the client device 102a may find information comprising what client applications are installed on the client device 102a, what files are located on the client device 102a, what user preferences have been set in the operating system, what user preferences have been set in various client applications, etc. In other embodiments, a user preference may be determined based, at least in part, on a system analysis performed on a server device, a network, and/or a plurality of client and/or server devices in communication with each other.

In one embodiment, user preference information may be inferred by monitoring activity on a client device. For example, by monitoring application usage, emails sent and received, instant messages, etc. User preference information can be used to set weights of different types, configurations, and contents of aspects, inserts, term input fields, transient menus, and different methods of displaying and otherwise outputting inserts and transient menus. In one embodiment a score may be determined for a particular insert. The insert may only be displayed if the weights of the associated aspect type and insert type exceed a predetermined threshold value. In one embodiment, a score may be determined for each possible method of displaying or otherwise outputting inserts and/or transient menus, and the method associated with the highest score may be used.

In another embodiment, a system may learn the weights of the various types, configurations and contents of aspects, inserts, term input fields, transient menus, and methods of displaying and otherwise outputting inserts and/or transient menus based on user activity. For example, if a user clicks on inserts or transient menus a percentage of the time the user accesses a client device corresponding to a particular aspect type, insert type and/or and insert display type, this information may be used to determine whether or not to perform a particular insertion. For example, consider an insert content of “the number of times the user has viewed an article” with an insert display type of “after the aspect” and an aspect type of a URL, a system may initially display such inserts with a particular probability, or if a score associated with the insert exceeds a threshold. In such a case, an insert might be displayed if the number of times the user has viewed an article exceeds three times. If the user clicks on such inserts often, the threshold for displaying the insert may be lowered—for example, such an insert may then be displayed whenever the number of times the user has viewed the article exceeds two times. Conversely, if a user rarely clicks on such an insert, the threshold may be increased, or the insert type or content may be abandoned completely. Thus, a system may learn which of the types, configurations and contents of aspects, inserts, term input fields, transient menus, and methods of displaying and otherwise outputting inserts and transient menus a user prefers over a period of time. In one such embodiment, a user preference may be determined based, at least in part, on a user action history comprising a plurality of user actions.

In one embodiment, the system allows the user to rate various types, contents or configurations of inserts and/or transient menus. For example, in one such embodiment, a request may be provided to the user in an insert requesting a rating of the current system configuration and/or inferred user preferences. In one such embodiment, a system may provide a user interface element the user can use to express such a rating, such as an “X” symbol to express negative interest, or a rating bar operable to allow a user to express a relative rating. In one embodiment, the user can open a customization menu for each insert and/or transient menu, allowing the user to configure preferences for a particular type, configuration, and/or content of an aspect, insert, term input field, transient menu, and/or method of displaying and otherwise outputting inserts and transient menus.

### General

The foregoing description of the exemplary embodiments of the invention has been presented only for the purpose of illustration and description and is not intended to be exhaustive or to limit the invention to the precise forms disclosed. Numerous modifications and adaptations thereof will be apparent to those skilled in the art without departing from the spirit and scope of the present invention.

1. A method comprising:
generating a user-context-dependent search query based, at least in part, on a user action history comprising a plurality of user actions performed on a plurality of articles;
identifying an aspect associated with an article;
generating an insert based, at least in part, on the aspect, wherein the insert comprises a search result associated with the aspect and generated responsive, at least in part, to searching an article index using the user-context-dependant search query; and
causing the insert to be output in association with the aspect.

2. (canceled)

3. The method of claim 1, wherein the article index comprises an index of articles available on the World Wide Web.

4. The method of claim 1, wherein the article index comprises a local article index.

5. The method of claim 4, wherein the local article index comprises a messaging index.

6. (canceled)

7. (canceled)

8. The method of claim 1, wherein the search result comprises at least one of an article identifier, a thumbnail, a text snippet, a Uniform Resource Locator, and a path.

9. The method of claim 1, wherein causing the insert to be output in association with the aspect comprises placing at least part of the insert into the article.

10. The method of claim 1, wherein causing the insert to be output in association with the aspect comprises causing the display of at least part of the insert in a transient display proximate to the aspect.

11. The method of claim 1, wherein causing the insert to be output in association with the aspect comprises causing the display of at least part of the insert in a window separate from the article.

12. The method of claim 1, wherein at least one of identifying the aspect, generating the insert, and causing the insert to be output in association with the aspect is based, at least in part, on a user preference.

13. The method of claim 12, further comprising receiving the user preference.

14. The method of claim 12, further comprising determining the user preference based, at least in part, on the user action history.

15. The method of claim 12, further comprising determining the user preference based, at least in part, on a system analysis.

16. The method of claim 1, wherein the aspect comprises a hyperlink.

17. The method of claim 1, wherein the aspect comprises a title.

18. The method of claim 1, wherein the aspect comprises an image.

19. The method of claim 1, wherein the aspect comprises a menu item.

20. The method of claim 1, wherein the aspect comprises an input field.

21. The method of claim 1, wherein the article comprises a web page.

22. The method of claim 1, wherein the article comprises a text document.

23. The method of claim 1, wherein the article comprises an email message.

24. The method of claim 1, wherein the article comprises an instant messenger message.

25. A method comprising:
identifying an aspect associated with an article;
automatically searching a local article index with a user-context-dependent search query for a search result associated with the aspect, wherein the user-context-dependent search query is based, at least in part on a user action history comprising a plurality of user actions performed on a plurality of articles;
automatically generating an insert comprising the search result;
placing the insert into the article such that the insert will be displayed near the aspect when the article is displayed; and
causing the article to be displayed.

26. A method comprising:
identifying an aspect associated with an article;
generating an insert based, at least in part, on the aspect, wherein the insert comprises a request; and
causing the insert to be output in association with the aspect.

27. The method of claim 26, wherein automatically generating the insert comprises generating a user context-dependent request.

28. The method of claim 26, wherein the user context-dependent request is based, at least in part, on a user action history comprising a plurality of user actions.

29. The method of claim 26, wherein the request comprises an article-related request.

30. The method of claim 26, wherein causing the insert to be output in association with the aspect comprises placing at least part of the insert into the article.

31. The method of claim 26, wherein causing the insert to be output in association with the aspect comprises causing the display of at least part of the insert in a transient display proximate to the aspect.

32. The method of claim 26, wherein causing the insert to be output in association with the aspect comprises causing the display of at least part of the insert in a window separate from the article.

33. The method of claim 26, wherein at least one of identifying the aspect, generating the insert, and causing the insert to be output in association with the aspect is based, at least in part, on a user preference.

34. The method of claim 33, further comprising receiving the user preference.

35. The method of claim 33, further comprising determining the user preference based, at least in part, on a user action history comprising a plurality of user actions.
based, at least in part, on a system analysis.

36. The method of claim 33, further comprising determining the user preference based, at least in part, on a system analysis.

37. The method of claim 26, wherein the aspect comprises a hyperlink.

38. The method of claim 26, wherein the aspect comprises a title.

39. The method of claim 26, wherein the aspect comprises an image.

40. The method of claim 26, wherein the aspect comprises a menu item.

41. The method of claim 26, wherein the aspect comprises an input field.

42. The method of claim 26, wherein the article comprises a web page.

43. The method of claim 26, wherein the article comprises a text document.

44. The method of claim 26, wherein the article comprises an email message.

45. The method of claim 26, wherein the article comprises an instant messenger message.

46. A method comprising:
identifying an aspect associated with an article;
generating a user context-dependent request associated with the aspect; automatically generating an insert comprising the request;
placing the insert into the article such that the insert will be displayed near the aspect when the article is displayed; and
displaying the article.

47. A tangible computer-readable medium on which is encoded program code, the program code comprising:
program code for generating a user-context-dependant search query based, at least in part, on a user action history comprising a plurality of user actions performed on a plurality of articles;
program code for identifying an aspect associated with an article;
program code for generating an insert based, at least in part, on the aspect, wherein the insert comprises a search result associated with the aspect and generated responsive, at least in part, to searching an article index using the user-context-dependent search query; and
program code for causing the insert to be output in association with the aspect.

48. (canceled)

49. The computer-readable medium of claim 47, wherein the article index comprises an index of articles available on the World Wide Web.

50. The computer-readable medium of claim 47, wherein the article index comprises a local article index.

51. The computer-readable medium of claim 50, wherein the local article index comprises a messaging index.

52. (canceled)

53. (canceled)

54. The computer-readable medium of claim 47, wherein the search result comprises at least one of an article identifier, a thumbnail, a text snippet, a Uniform Resource Locator, and a path.

55. The computer-readable medium of claim 47, wherein the program code for causing the insert to be output in association with the aspect comprises program code for placing at least part of the insert into the article.

56. The computer-readable medium of claim 47, wherein the program code for causing the insert to be output in association with the aspect comprises program code for causing the display of at least part of the insert in a transient display proximate to the aspect.

57. The computer-readable medium of claim 47, wherein the program code for causing the insert to be output in association with the aspect comprises program code for causing the display of at least part of the insert in a window separate from the article.

58. The computer-readable medium of claim 47, wherein the program code for at least one of identifying the aspect, generating the insert, and causing the insert to be output in association with the aspect is based, at least in part, on a user preference.

59. The computer-readable medium of claim 58, further comprising program code for receiving the user preference.

60. The computer-readable medium of claim 58, further comprising program code for determining the user preference based, at least in part, on the user action history.

61. The computer-readable medium of claim 58, further comprising program code for determining the user preference based, at least in part, on a system analysis.

62. A computer-readable medium on which is encoded program code, the program code comprising:
program code for identifying an aspect associated with an article;
program code for generating an insert based, at least in part, on the aspect, wherein the insert comprises a request; and
program code for causing the insert to be output in association with the aspect.

63. The computer-readable medium of claim 62, wherein the program code for automatically generating the insert comprises program code for generating a user context-dependent request.

64. The computer-readable medium of claim 63, wherein the user context-dependent request is based, at least in part, on a user action history comprising a plurality of user actions.

65. The computer-readable medium of claim 62, wherein the request comprises an article-related request.

66. The computer-readable medium of claim 62, wherein the program code for causing the insert to be output in association with the aspect comprises program code for placing at least part of the insert into the article.

67. The computer-readable medium of claim 62, wherein the program code for causing the insert to be output in association with the aspect comprises program code for causing the display of at least part of the insert in a transient display proximate to the aspect.

68. The computer-readable medium of claim 62, wherein the program code for causing the insert to be output in association with the aspect comprises program code for causing the display of at least part of the insert in a window separate from the article.

69. The computer-readable medium of claim 62, wherein the program code for at least one of identifying the aspect, generating the insert, and causing the insert to be output in association with the aspect is based, at least in part, on a user preference.

70. The computer-readable medium of claim 69, further comprising program code for receiving the user preference.

71. The computer-readable medium of claim 69, further comprising program code for determining the user preference based, at least in part, on a user action history comprising a plurality of user actions.

72. The computer-readable medium of claim 69, further comprising program code for determining the user preference based, at least in part, on a system analysis.
